(19) United States
(12) Patent Application Publication
(10) Pub. No.: US 2011/0262212 A1
(43) Pub. Date: Oct. 27, 2011

(54) WORK TOOL COUPLING ARRANGEMENT

(75) Inventors: Joost Luyendijk, Rosmalen (NL); Edward Amelsfoort, Tilburg (NL)

(73) Assignee: CATERPILLAR WORK TOOLS B.V., 's-Hertogenbosch (NL)

(21) Appl. No.: 13/131,323

(22) PCT Filed: Nov. 27, 2008
(86) PCT No.: PCT/NL2008/050756

§ 371 Date: Jul. 7, 2011

(51) Int. Cl. E02F 3/36; B23P 11/00

(52) U.S. Cl. 403/31; 29/428

(57) ABSTRACT

A coupling arrangement for coupling a work tool to a machine is disclosed. The coupling arrangement has a locking arrangement for locking the work tool to the machine. The coupling arrangement further has at least two fluid couplers arranged to be connected to each other for establishing a fluid passage between a main pressurized fluid circuit channel of a work tool and a main pressurized fluid circuit channel of a machine. The coupling arrangement further has a driving arrangement for driving at least one of the fluid couplers for connection to the other fluid coupler, the driving arrangement being separate from the main pressurized fluid circuit.

### TECHNICAL FIELD

The present disclosure is directed to a coupling arrangement, more particular to a coupling arrangement for coupling a work tool to a machine.

### BACKGROUND

Work tools, such as shears, grabs, or buckets are oftentimes coupled with host machines, such as excavators, to perform work operations like cutting, grabbing or excavating. The work tools may be coupled to a boom or stick mechanism of the host machine via a fixed connection or a quick release connection. The latter allows for a relatively easy exchange of the work tool, wherein the operator may connect or change a work tool without leaving the cab. The machine mounting bracket is arranged to slide into the work tool mounting bracket, when the work tool is positioned on the ground. After the mounting bracket of the work tool and the mounting bracket of the machine are aligned, a locking wedge or pin can move into a locked position to lock the work tool to the machine.

When connecting the work tool to the machine, the hydraulic hoses of the main pressurized fluid circuit also need to be connected for driving the work tool. Automatic hydraulic hose connection systems are known, wherein the operator can activate the hydraulic hose connection from the cab. Such systems often rely on the connection of the work tool to the machine, wherein hydraulic hose couplers are provided that are arranged so that during connection of the work tool to machine the hose couplers are also automatically connected. When the work tool mounting bracket is slit into the machine mounting bracket, at the same time, the hose couplers may be connected. However, it is found that aligning the hose couplers may need a higher level of accuracy than alignment of the mounting brackets. In practice, when a coupling arrangement is provided with such hose couplers, an operator may try to avoid the relatively rough movements and high forces that are typical for connecting the work tool to the machine. This may result in loss in efficiency, or a limited amount of experienced operators capable of establishing the coupling. Still a relatively high risk of causing damage to the hydraulic hose couplers remains, because of the high forces and rough alignments between the mounting brackets. When the hose couplers are not aligned accurately, pressurized fluid may escape or the couplers and/or hoses may need to be changed. Since the hydraulic circuits of host machines may operate under relatively high pressures, any leakage may cause major spillage of the fluid and significant downtime.

A coupling arrangement for coupling two ends of a pressurized hydraulic fluid circuit of a work tool and a machine is disclosed in European patent application EP1388616. The coupling arrangement comprises a quick release mounting bracket for coupling a work tool to a machine. The coupling arrangement comprises a receiving fluid coupler and a moving fluid coupler, each coupler being connected to a hydraulic hose of a main hydraulic circuit. One of the couplers is arranged on the work tool, the other coupler is arranged on the machine. Both couplers may be connected to each other for providing a fluid passage between the hydraulic hoses, so that pressurized fluid may circulate in the main hydraulic circuit. The moving fluid coupler is connected to a hydraulic actuator. The actuator moves the moving fluid coupler to and from the receiving fluid coupler. The actuator is connected to and driven by the main hydraulic circuit, which is primarily arranged for driving the work tool and therefore operates under relatively high pressure. Since the actuator is driven by the main hydraulic circuit, the pressure of the hydraulic circuit is much higher than needed for driving the hydraulic actuator for moving the moving fluid coupler. Damage may easily occur. Furthermore, during movement of the coupler to couple the hydraulic circuit, the hydraulic hoses may become wedged, caught, or trapped in or between the structure of the machine and/or the work tool.

### SUMMARY OF THE INVENTION

In one aspect, the present disclosure is directed to a coupling arrangement for coupling a work tool to a machine. The coupling arrangement has a locking arrangement for locking the work tool to the machine. The coupling arrangement also has at least two fluid couplers arranged to be connected to each other for establishing a fluid passage between a main pressurized fluid circuit channel of a work tool and a main pressurized fluid circuit channel of a machine. Further, a driving arrangement is provided for driving at least one of the fluid couplers for connection to the other fluid coupler, the driving arrangement being separate from the main pressurized fluid circuit.

In another aspect, the present disclosure is directed to a method of coupling a fluid coupler of a machine to a fluid coupler of a work tool. The method includes locking the work tool to the machine so that the fluid couplers are aligned with each other. The method also includes moving at least a part of one of the fluid couplers, with a driving arrangement separate from the main pressurized fluid circuit, in the direction of the other fluid coupler. The method further includes establishing a fluid passage between the fluid coupler of the machine and the fluid coupler of the work tool.

### BRIEF DESCRIPTION OF THE DRAWINGS

FIG. 1 is a side view of a machine and a work tool provided with a coupling arrangement.

FIG. 2 is a perspective view of a coupling arrangement, before it is locked.

FIG. 3 is a perspective, cross-sectional view of the coupling arrangement of FIG. 2.

FIG. 4 is a perspective, cross-sectional view of the coupling arrangement of FIGS. 2 and 3, wherein the coupling arrangement is locked, and the fluid couplers are aligned.

FIG. 5 is a perspective, cross-sectional view of the coupling arrangement of FIGS. 2, 3 and 4, wherein the coupling arrangement is locked, and the fluid couplers are coupled.

FIG. 6 is a flow chart of a method of coupling a work tool to a machine.

### DETAILED DESCRIPTION

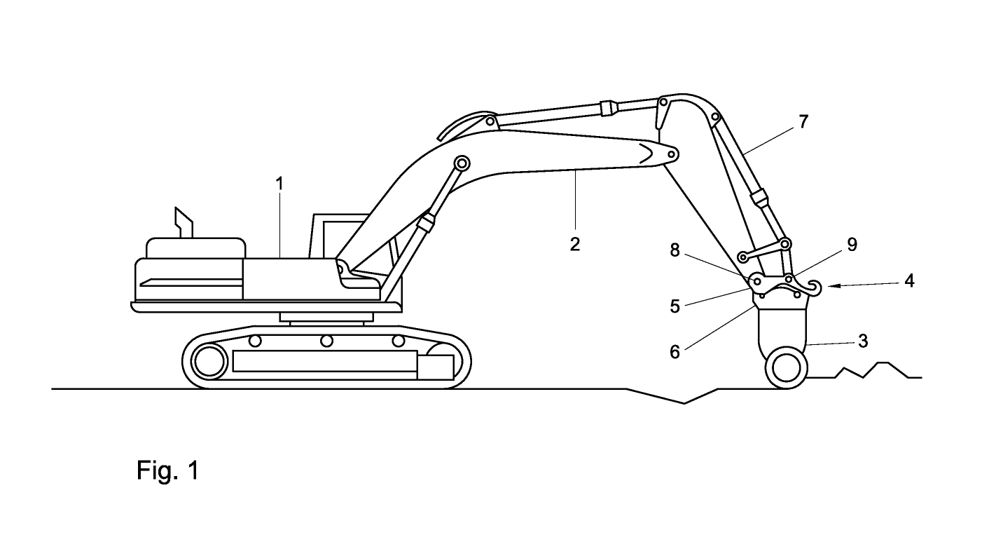

FIG. 1 illustrates an exemplary machine 1, which may be a host machine 1. The machine 1 may be a mobile machine such as for example an excavator, a back hoe, a digger, a loader, a knuckle boom loader, a harvester or a forest machine. The machine 1 as shown in the exemplary embodiment of FIG. 1 is a hydraulic excavator, provided with a boom 2, in particular a hydraulic boom mechanism for driving the boom 2 and/or a work tool 3. The work tool 3 may be coupled to the machine 1, in particular to the boom 2. In the exemplary embodiment shown, the work tool 3 comprises a rotary cutter. In other embodiments, usable work tools 3 may for example include cutters, augers, buckets, blades, brooms, cutters, cold planers, compactors, delimbers, forks, grapples, hammers, hoppers, mulchers, multi-processors, pulverizers, rakes, rippers, saws, scarifiers, shears, plows, grinders, thumbs, tillers, trenchers, truss booms, or the like. For example, the work tool 3 may comprise a frame that in itself carries multiple exchangeable and/or interexchangeable tools. In an embodiment, the work tool 3 may comprise a demolition work tool 3, or at least a work tool 3 for heavy duty applications.

The machine 1 may be provided with a coupling arrangement 4. The coupling arrangement 4 may comprise a machine mounting bracket 5 and a work tool mounting bracket 6. The machine mounting bracket 5 may be coupled to the machine 1. The work tool mounting bracket 6 may be coupled to the work tool 3. The mounting brackets 5, 6 are arranged to be coupled to each other. If the mounting brackets 5, 6 are coupled to the machine 1 and the work tool 3, respectively, this may allow the work tool 3 to be coupled to the boom 2 by operating the boom 2 from the machine cab.

A pressurized fluid assembly 7 may extend along the boom 2 for moving the boom 2 and the work tool 3. The end of the pressurized fluid assembly 7 may be attached to the machine mounting bracket 5. The pressurized fluid assembly 7 may be arranged to retract and extend with respect to the boom 2, for moving the work tool 3.

The pressurized fluid assembly 7 may form part of a main pressurized fluid circuit for driving the boom 2 and the work tool 3. The main pressurized fluid circuit may extend in and/or along the boom 2 and the work tool 3, so that the work tool 3, or parts thereof, may perform work operations. A portion of the main pressurized fluid circuit may extend in and/or along the machine 1. A second portion of the main pressurized fluid circuit may extend in and/or along the work tool 3. The main pressurized fluid circuit may comprise a hydraulic circuit. The main pressurized fluid circuit may be provided with a pump for driving and circulating the fluid through the circuit. The main pressurized fluid circuit may be arranged to drive the fluid at relatively high pressure and speed, for example at least approximately 150 liters per hour, or at least approximately 250 liters per hour, for example approximately 300 liters per hour. The main pressurized fluid circuit may comprise fluid circuit channels for guiding the pressurized fluid. The fluid circuit channels may comprise at least partly flexible hoses.

As shown in FIG. 1, the boom 2 may be coupled to the machine mounting bracket 5 via a first pin 8. The first pin 8 may also be referred to as stick pin. The pressurized fluid assembly 7 may be coupled to the machine mounting bracket 5 via a second pin 9. The second pin 9 may also be referred to as a power link pin.

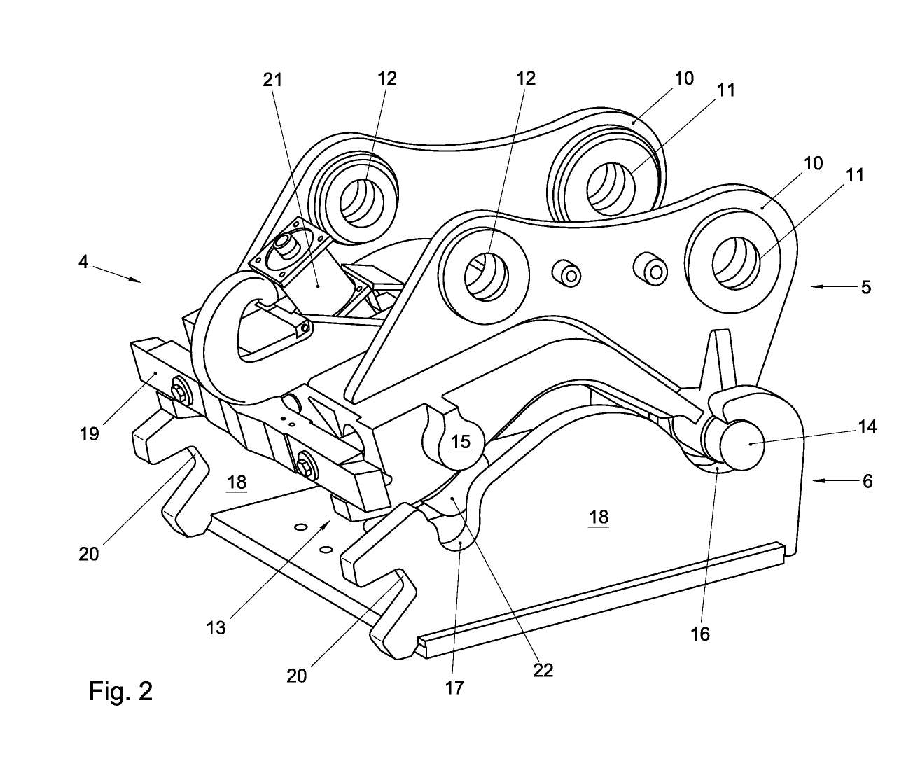

FIG. 2 illustrates the coupling arrangement 4. The coupling arrangement 4 may comprise an assembly of mounting brackets 5, 6. The top part of the coupling arrangement 4 may comprise the machine mounting bracket 5. The bottom part of the coupling arrangement 4 may comprise the work tool mounting bracket 6. The assembly of mounting brackets 5, 6 may also be referred to as quick release mounting bracket and/or quick coupler. The machine mounting bracket 5 may comprise flanges 10 for connecting the mounting bracket 5 to the end of the boom 2 and to the pressurized fluid assembly 7, with the aid of the first and second pins 8, 9, respectively. The flanges 10 may be provided with axle openings 11, 12. First pin receiving openings 11 may serve as bearing locations for supporting the first pin 8. The first pin 8 may form a pivot axis about which the work tool 3 may pivot with respect to the boom 2. Second pin receiving openings 12 may serve as bearing locations for supporting the second pin 9, so that the pressurized fluid assembly 7 may drive the work tool 3 to pivot with respect to the boom 2 about the first pin 8.

The coupling arrangement 4 may be provided with a locking arrangement 13. The locking arrangement 13 may be arranged for locking the machine mounting bracket 5 to the work tool mounting bracket 6, for locking the work tool 3 to the machine 1. The locking arrangement 13 may comprise inserts 14, 15 on one mounting bracket 5, and corresponding insert receiving elements 16, 17 on the other mounting bracket, for coupling the mounting brackets 5, 6. The machine mounting bracket 5 may be provided with four inserts 14, 15. The work tool mounting bracket 6 may be provided with four insert receiving elements 16, 17, for receiving said four inserts 14, 15. The work tool mounting bracket 6 may comprise two opposite flanges 18, wherein the insert receiving elements 16, 17 are arranged. Each flange 18 may comprise two insert receiving elements 16, 17 for receiving two inserts 14, 15. The insert receiving elements 16, 17 may comprise indentations and/or hooks or the like, that are arranged along the edge of the flanges 18. First inserts 14 may be arranged to be coupled to first insert receiving elements 16. The first inserts 14 may be arranged in the machine mounting bracket 5, near the first pin receiving openings 11, and/or spaced away from the second pin receiving openings 12. The first insert receiving element 16 for receiving the first inserts 14 may be hook-shaped for allowing the work tool 3 to be lifted from the ground when it is coupled via the first inserts 14 and first insert receiving elements 16. Second inserts 15 may be arranged to be coupled to second insert receiving elements 17. The second inserts 15 may be arranged near the second pin receiving openings 12, and/or away from the first pin receiving openings 11. The second inserts 15 may be arranged at the side where the pressurized fluid assembly 7 may be connected to the machine mounting bracket 5. The second insert receiving elements 17 may comprise cut-outs in the flanges 18 of the work tool mounting bracket 6, for receiving the second inserts 15.

The locking arrangement 13 may further be provided with locking member 19 that is arranged to move between a locked position and an unlocked position. The locking member 19 may be provided in the machine mounting bracket 5. The locking member 19 may be arranged to extend and retract with respect to the machine mounting bracket 5. In the shown embodiment, the locking member 19 may comprise a bar. In other embodiments, the locking member 19 may comprise a stick, hook, wedge or the like. The locking member 19 may be arranged to keep the brackets 5, 6 in a locked condition after coupling the brackets 5, 6, which may prevent the brackets 5, 6 being unlocked by accident. The locking arrangement 13 may further comprise one or more locking member receiving elements 20, for receiving the locking member 19 in the locked position. The locking member receiving elements 20 may be provided in the work tool mounting bracket 6. The locking member receiving elements 20 may comprise cut-outs and/or hooks. The locking member receiving elements 20 may be arranged in the flanges 18 of the work tool mounting bracket 6. The locking member receiving elements 20 may be arranged near the second insert receiving elements 17.

The locking arrangement 13 may be provided with a secure element that may be arranged to keep the locking member 19 in a locked position when the driving arrangement would loose pressure and/or would fail. The secure element may comprise a resilient element, such as a helical spring, that pulls and/or pushes the locking member 19 in a locked position, into and/or against the locking member receiving element 20.

The locking arrangement 13 may be provided with a driving arrangement for moving the locking member 19 between the locked and unlocked position. The driving arrangement may comprise a second pressurized fluid circuit that is separate from the main pressurized fluid circuit. The driving arrangement may have a significant lower fluid pressure than the main pressurized fluid circuit. The driving arrangement for driving the locking member 19 may be arranged to drive the fluid at speeds of between approximately 3 and 50 liters per minute, or between approximately 7 to 30 liters per minute, for example between approximately 10 and 15 liters per minute. In other embodiments, the driving arrangement may comprise a rotational or linear motor, a pneumatic drive, a manually actuated drive, or another type of driving arrangement. The locking arrangement 13 and the driving arrangement may be arranged to move the locking member 19 from a locked position into a unlocked position against the force of the secure element. The locking arrangement 13 may be arranged such that the locking member 19 may be moved towards the locked position by the force of the secure element, wherein the driving arrangement may be arranged to release pressure to allow such movement.

The coupling arrangement 4 may further be provided with at least two fluid couplers 21, 22, that are arranged to be connected to each other for establishing a fluid passage for the main pressurized fluid circuit, between the machine 1 and the work tool 3. The fluid couplers 21, 22 may be arranged so that the ends of the fluid circuit channels of the main pressurized fluid circuit of the machine may be coupled to the ends of the fluid circuit channels of the main pressurized fluid circuit of the work tool 3. A first fluid coupler 21 may be arranged in the machine mounting bracket 5. A second fluid coupler 22 may be arranged in the work tool mounting bracket 6. The first fluid coupler 21 may be fixedly connected to a first fluid circuit channel of the pressurized fluid assembly 7. The second fluid coupler 22 may be fixedly connected to a second fluid circuit channel of the work tool 3. The second fluid circuit channel may extend along and/or in the work tool 3. The fluid circuit channels may comprise hoses for guiding the pressurized fluid.

In FIG. 2, one pair of fluid couplers 21, 22 is shown for providing a fluid passage of the main pressurized fluid circuit. In practice, multiple pairs of fluid couplers 21, 22 may be provided, for providing one or more fluid passages extending between the machine 1 and the work tool 3, for allowing fluid to flow from the machine 1 to the work tool 3, and from the work tool 3 to the machine 1.

The fluid couplers 21, 22 may be arranged within the respective mounting brackets 5, 6. The first fluid couplers 21 may be arranged between the flanges 10 of the machine mounting bracket 5. The second fluid couplers 22 may be arranged between the flanges 18 of the work tool mounting bracket 6. In other embodiments, the mounting brackets 5, 6 may comprise frames and the fluid couplers 21, 22 may be arranged within and/or between the frames. In again another embodiment, the coupling arrangement 4 may be arranged to couple the may be arranged fluid couplers 21, 22 may be coupled directly to the machine 1 and to the work tool 3, respectively.

At least one of the fluid couplers 21, 22 may be at least partly moveable with respect to the respective fluid circuit channel, for being coupled to a corresponding fluid coupler 21, 22. The first fluid coupler 21 may comprise an extendable fluid coupler 21. The second fluid coupler 22 may comprise a receiving fluid coupler for receiving the moveable part of the extendable first fluid coupler 1. Alternatively, the first fluid coupler 21 may comprise the receiving fluid coupler, and the second fluid coupler 22 may comprise the extendable fluid coupler.

A driving arrangement may be provided for driving the moveable fluid coupler part. The driving arrangement may be arranged to drive the moveable fluid coupler part, only when the brackets 5, 6 are locked with respect to each other, so that the couplers 21, 22 may be properly aligned before coupling them. The driving arrangement for driving the fluid coupler 21, 22 may be separate from the main pressurized fluid circuit. The driving arrangement for driving the moveable fluid coupler part may be arranged for driving the locking member 19 as well. The driving arrangement may comprise a second pressurized fluid circuit that is separate from the main pressurized fluid circuit. Alternatively, the driving arrangement may comprise a rotational or linear motor, a pneumatic drive, a manually actuated drive, or another type of driving arrangement.

The driving arrangement for driving the fluid coupler 21, 22 and/or the locking member 19 may be arranged to drive the fluid at a relatively low pressure, as compared to the main pressurized fluid circuit. The driving arrangement may be arranged to drive the fluid at speeds of between approximately 3 and 50 liters per minute, or between approximately 7 to 30 liters per minute, for example between approximately 10 and 15 liters per minute. The pressure and/or speed of the driving arrangement may be similar to the pressure and/or speed that is applied in common type hydraulic actuators. The driving arrangement may comprise a hydraulic circuit.

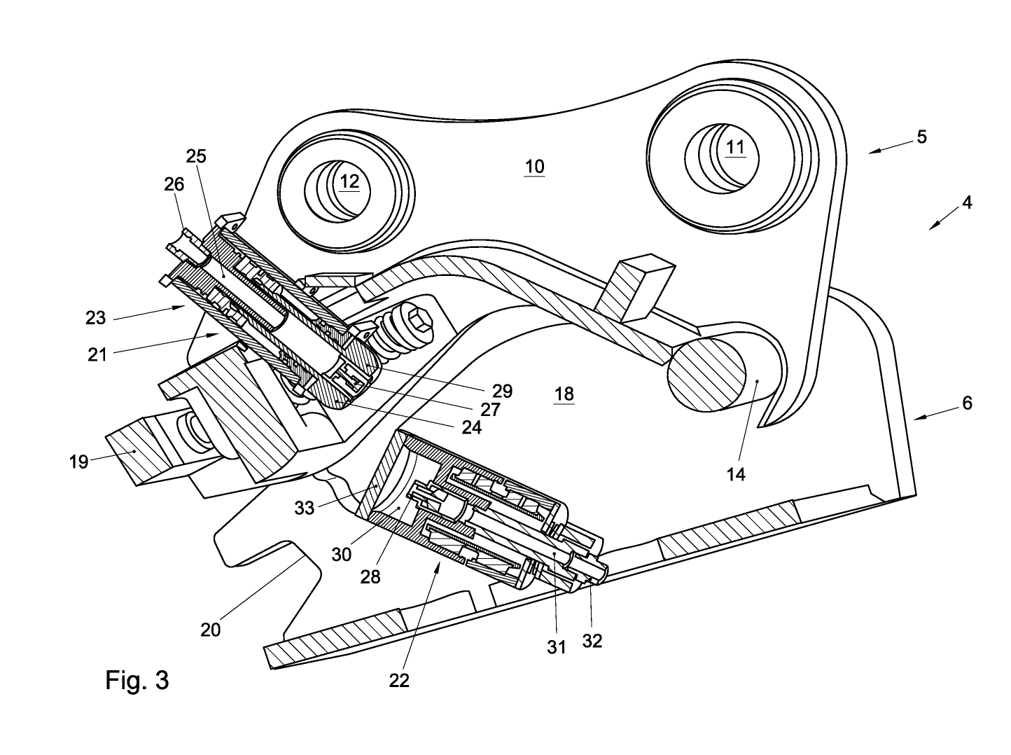

FIG. 3 illustrates a cross-sectional view of the assembly shown in FIG. 2. As shown, the first fluid coupler 21 may comprise an extendable fluid coupler. The extendable fluid coupler may comprise a guiding portion 23 and a piston 24. Both portions 23, 24 may be cylindrically shaped. The guiding portion 23 and the piston 24 may have a common central axis. A first fluid passage 25 may be provided in the first fluid coupler 21. The first fluid coupler 21 may extend through the guiding portion 23 and/or the piston 24. The first fluid passage 25 may extend centrally through the guiding portion 23 and the piston 24, along the central axis. The guiding portion 23 may be arranged for guiding the piston 24 along the central axis. The piston 24 may be extendable with respect to the guiding portion 23. The guiding portion 23 may be provided with a connection element 26 for connection of the first fluid passage 25 to the fluid circuit channel of the main pressurized fluid circuit. The piston 24 may be arranged to move with respect to the fluid circuit channel.

At the distal end of the piston 24 a piston valve 27 may be provided that may close off the first fluid passage 25 when it is not connected to the receiving pressurized fluid coupler, to prevent spilling of fluid. The piston valve 27 may be connectable to a corresponding receiving valve 28 of the second fluid coupler. The piston valve 27 may comprise a male or female element for cooperation with a female or male element, respectively, of the corresponding receiving valve 28, so that a fluid tight connection between the pressurized fluid circuit channels of the work tool 3 and the machine 1 may be established. The valves 27, 28 may comprise dry-break valves. The valves 27, 28 may be arranged to prevent spillage of fluid during connection of the first and second fluid coupler 21, 22 at relatively high pressures of the fluid in the main pressurized fluid circuit.

The piston 24 may have a tapered end 29 for alignment with the second fluid coupler 22. The second fluid coupler 22 may comprise a receiving opening 30 for receiving the piston 24. The tapered end 29 may be arranged to guide and align the piston 24 with respect to the receiving opening 30 of the second fluid coupler 22, so that the valve 27 of the piston 24 is connected to the valve 28 of the second fluid coupler 22.

The second fluid coupler 22 may be provided with a second fluid passage 31 along its central axis. At the end of the second fluid passage 31, the receiving valve 28 may be provided for cooperation with the piston valve 27. The piston valve 27 and/or the receiving valve 28 may prevent spilling of pressurized fluid and may be known in the field as a dry break valve assembly.

The receiving opening 30 of the second fluid coupler 22 may be arranged to guide and/or partly enclose a head of the piston 24 during connection. The receiving opening 30 may have a central axis common to the central axis of the second fluid coupler 22. The second fluid coupler 22 may comprise a connection element 32 to connect the second fluid passage 31 of the second fluid coupler 22 with the respective fluid circuit channel.

At least one of the couplers 21, 22 may be provided with a cover 33 for covering an end of the respective coupler 21, 22. The cover 33 may be arranged to cover an end of the first and/or second fluid passage 25, 31, at least when the couplers 21, 22 are disconnected from each other. The cover 33 may be arranged to cover the respective valve 27, 28, at least when the couplers 21, 22 are disconnected from each other. As shown, the second fluid coupler 22 may be provided with such cover 33. Similarly, the first coupler 21 may be provided with a cover 33.

The cover 33 may be arranged to be mechanically activated by movement of at least a part of the coupling arrangement 4. The cover 33 may also be arranged to be moved by a movement of one of the couplers 21, 22 with respect to the other coupler 22, 21. The cover 33 may comprise a slide that is arranged to be pushed way from the end of the respective coupler 21, 22. The cover 33 may be arranged to be moved away by the first coupler 21, when the couplers 21, 22 move towards each other, so that it slides off the respective end of the second coupler 22. The cover 33 may be arranged to be pushed away by the piston 24, when the piston 24 moves toward the second coupler 22. Alternatively, the first coupler 21 may comprise a notch or finger that pushes the cover 33 when the moveable part move towards the second coupler 22. The notch or finger may push the cover 33 into an uncovered position while the mounting couplers 21, 22 move towards each other. The cover 33 may further be provided with a resilient element, so that after uncoupling of the couplers 21, 22 the cover 33 may move back into a position for covering the respective coupler 21, 22. Alternatively, the cover 33 may be arranged to be moved by a relative movement of one of the mounting brackets 5, 6, with respect to the other mounting bracket 6, 5.

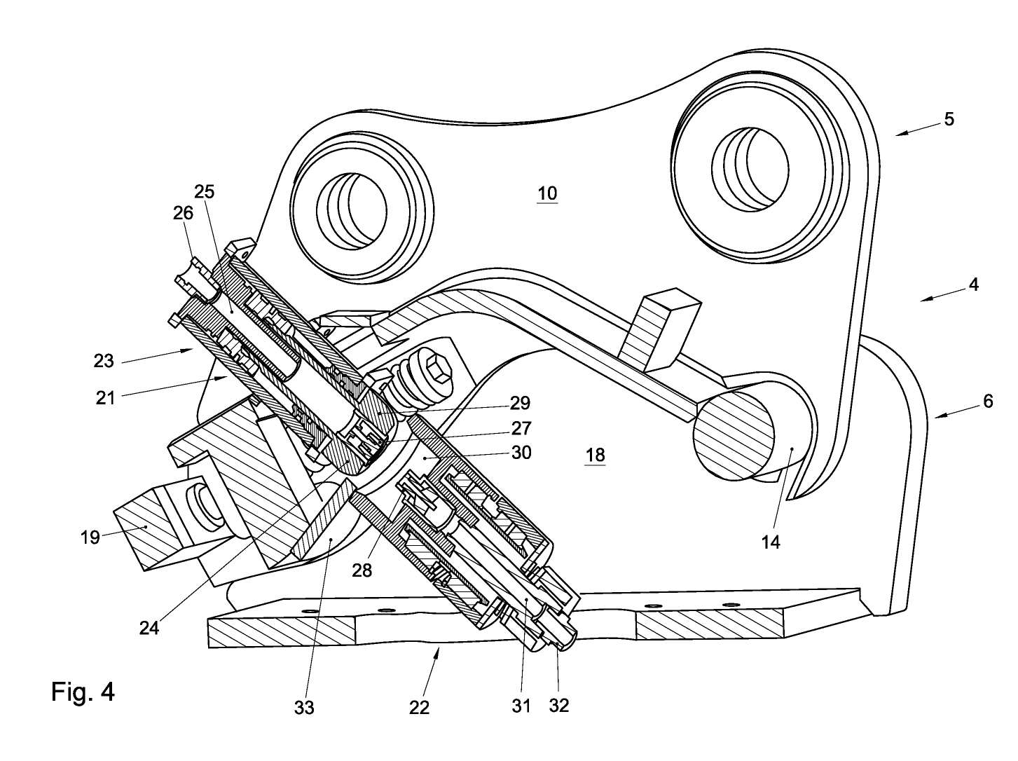

FIG. 4 illustrates a cross-sectional view of the coupling arrangement 4 in a locked position. The work tool 3 may be locked to the machine 1 when the inserts 14, 15 are positioned in the respective insert receiving elements 16, 17 and the locking member 19 is in a locked position. The fluid couplers 21, 22 may be arranged to be in alignment with each other when the work tool 3 is locked to the machine 1, so that the couplers 21, 22 may be coupled to each other. The fluid couplers 21, 22 may be aligned so that the moveable coupler may be coupled to the receiving coupler by a substantially straight movement of the moveable coupler.

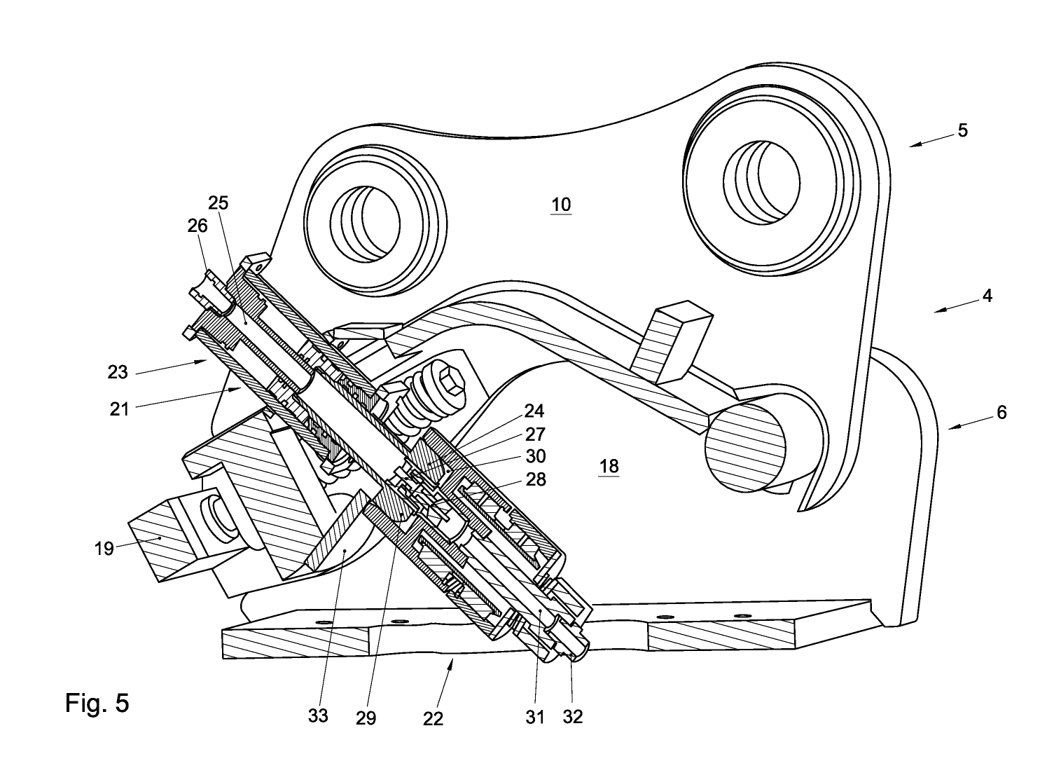

FIG. 5 illustrates a cross-sectional view of the coupling arrangement 4 in a locked position, while the fluid couplers 21, 22 are coupled. In a coupled condition of the couplers 21, 22, the first coupler 21 may be extended so that the piston 24 is received by the receiving opening 30 of the second coupler 22, while the guiding portion 23 and the fluid circuit channel that is connected to the first coupler 21 may remain in place. In the coupled condition, the valves 27, 28 may be interconnected so that a fluid passage through the valves 27, 28 is established. In the coupled condition of the couplers 21, 22, pressurized fluid may extend centrally within the fluid couplers 21, 22

### INDUSTRIAL APPLICABILITY

In general, work tools 3 are used for handling heavy materials. For example, the work tools 3 may demolish, drill, dig, plow, cut, grab and/or carry heavy materials which may include sand, stone, metal, and more. Work tools 3 may be coupled to and powered by machines 1, in particular mobile host machines. The machine 1 may be provided with transmissions, hydraulic equipment, booms 2 and/or sticks for driving the work tool 3. Work tool operations may be controlled by the operator via an operating panel in the cab of the machine 1. Mounting brackets 5, 6 may permit that the work tool 3 is coupled and locked to the machine 1 without the operator having to leave the cab. Fluid couplers 21, 22 may permit that the fluid circuit channels of the machine 1 and the fluid circuit channels of the work tool 3 are coupled, so that a fluid passage is established. In a coupled condition, fluid may flow through the fluid circuit channels and the couplers 21, 22 at speeds of at least approximately 150, or at least approximately 250 liters per minute, for operating relatively heavy work tool operations.

To provide the fluid tight connection in a relatively accurate and secure manner, a moveable coupler part of the couplers 21, 22 may be driven by a separate driving arrangement, separately from the main pressurized fluid circuit, at a pressure that may be adapted for driving the moveable coupler 21. Hence, movement of the at least one of the couplers 21, 22, or a part of one of the couplers 21, 22, may be controlled more effectively. Moreover, when the main pressurized fluid circuit would loose pressure, in case of failure, the separate driving arrangement may remain unaffected, so that the fluid couplers 21, 22 may remain in a coupled, or at least in an operable condition.

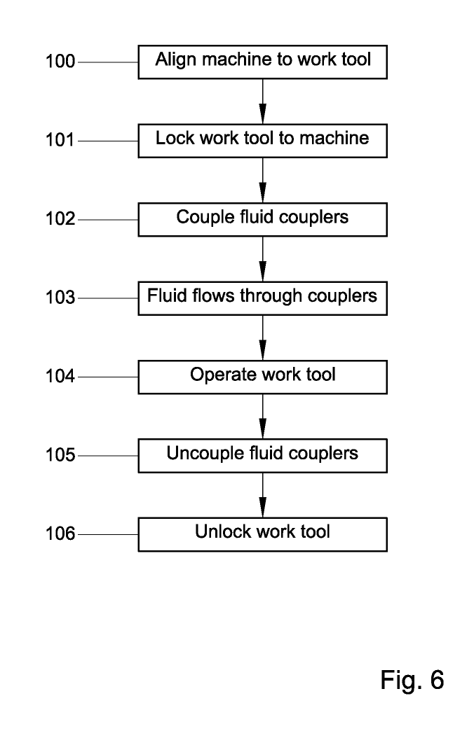

Referring to the exemplary disclosed flow chart of FIG. 6, in a first step 100 of coupling the first fluid coupler 21 to the second fluid coupler 22, the machine 1 may be aligned with the work tool 3. The boom 2 may be moved such that the machine mounting bracket 5 is aligned with the work tool mounting bracket 6. The first inserts 14 of the machine mounting bracket 5 may be inserted into the first insert receiving elements 16 of the work tool mounting bracket 6. The machine mounting bracket 5 may then pivot about the first inserts 5 until the second inserts 15 of the machine mounting bracket 5 are received in the second insert receiving elements 17 of the work tool mounting bracket 6. The machine mounting bracket 5 may be moved by the pressurized fluid assembly 7.

In a second step 101, the work tool 3 may be locked to the machine 1. The locking member 19 may be moved in a locked position, wherein it abuts the locking member receiving elements 20. The locking member 19 may be activated into a locked position after both inserts 14, 15 are received in the corresponding insert receiving elements 16, 17, respectively. The locking member 19 may be driven by the driving arrangement. In another embodiment, the locking member 19 may move towards the locked position by the force of the secure element, wherein the driving arrangement may release pressure, so that the secure element pushes or pulls the locking member 19 into a locked position. When the work tool 3 is locked to the machine 1, the fluid couplers 21, 22 may be aligned with respect to each other.

In a third step 102, the fluid couplers 21, 22 may be coupled to establish a fluid passage between the fluid circuit channels of the work tool and the fluid circuit channels of the machine, the channels being part of the main pressurized fluid circuit. The piston 24 of the first coupler 21 may extend towards the second coupler 22. The piston 24 of the first coupler 21 may be driven by the driving arrangement. The piston 24 may be driven into the receiving opening 30 of the second fluid coupler 22. The tapered end 29 of the piston 24 may guide the piston 24 into the receiving opening 30, so that the piston valve 27 and the receiving valve 28 may connect. The valves 27, 28 may connect so that a fluid tight passage is established between the first fluid passage 25 and the second fluid passage 31. While the piston 24 is moved, the fluid circuit channels that are connected to the respective couplers 21, 22 may remain static, at least with respect to the mounting brackets 5, 6. The piston 23 may extend away from the guiding portion 23 and the first fluid circuit channel that is connected thereto by the connection element 26.

Before the work tool 3 and the machine 1 are coupled the cover 33 may cover the respective end of at least one of the couplers 21, 22, to prevent dust and/or particles contaminating the respective valves 27, 28. When the piston 24 is moved into the receiving opening 30, the cover 33 may be moved from the couplers 21, 22, to release the valves 27, 28. The cover 33 may be pushed away by the piston 24. The cover 33 may pivot about a hinge and/or may be activated by the driving arrangement. In another embodiment, the cover 33 may be moved from the respective coupler end when the mounting brackets 5, 6 are connected.

In a fourth step 103, fluid may circulate through the main pressurized fluid circuit. The fluid may flow through the couplers 21, 22, from the fluid circuit channels of the machine 1 to the fluid circuit channels of the work tool 3, and back to the fluid circuit channels of the machine 1. The pressurized fluid may pass through the couplers 21, 22. The pressurized fluid may pass through the hoses that form the fluid circuit channels, and centrally through the couplers 21, 22, through the first fluid passage 25 of the first fluid couplers 21, and through the second fluid passage 31 of the second fluid couplers 22.

In a fifth step 104, the fluid may drive the work tool 3 to perform work operations. The work tool 3 may perform relatively heavy operations such as demolishing.

In a sixth step 105, the couplers 21, 22 may be uncoupled. During uncoupling of the couplers 21, 22, and the valves 27, 28, the machine 1 and the work tool 3 may remain in a locked condition, so that the couplers 21, 22 may remain in alignment with respect to each other. The piston 24 may move away from the second coupler 22, along the central axis of the first coupler 21, while the locking member 19 is still engaging the locking member receiving element 20. During movement of the piston 24, the respective fluid circuit channel may remain static with respect to the mounting brackets 5, 6.

In a seventh step 106, the work tool 3 is unlocked with respect to the machine 1, after the couplers 21, 22 have already been uncoupled. The locking member 19 may move out of the locking member receiving element 20, with the aid of the driving arrangement. After unlocking, the inserts 14, 15 may be moved out of the insert receiving elements 16, 17 so that the work tool 3 may be released from the machine 1. For example, another work tool 3 may be attached to the machine 1, and a method as discussed here above with reference to FIG. 6 may be repeated.

The couplers 21, 22 may be aligned relatively accurately with respect to each other, because the coupling of the couplers 21, 22 may take place after the work tool 3 is locked to the machine 1. Such accurate alignment may prevent leakage of pressurized fluid and/or damage of the couplers 21, 22. Moreover, by employing a coupler 21 having an extendable portion with respect to a guiding portion 23, the pressurized fluid circuit channels may be coupled to the guiding portion 23. Hence, the pressurized fluid channels may remain in position while a portion of the coupler 21 is moved for coupling. Hence, possible damage to the respective fluid circuit channels such as hoses may be prevented because repetitive movement of the hoses is prevented. Since only a part of the couplers 21, 22 is moved and the fluid circuit channels may remain static, the couplers 21, 22 may be arranged to the machine 1, work tool 3, and/or mounting bracket 5, 6 in a relatively confined space, preferably in and/or between the mounting brackets 5, 6. Relatively quick coupling and/or quick release interfaces may be employed, wherein coupling of the work tool 3 to the machine 1, as well as a coupling of the fluid circuit channels may be achieved in a relatively safe and efficient manner, without an operator having to leave the cab.

It shall be readily apparent to the skilled person that various modifications and variations can be made without departing from the scope or spirit of the disclosure. Other embodiments of the disclosure will be apparent to those skilled in the art from consideration of the specification and practice of the disclosure disclosed herein. It is intended that the specification and examples be considered as exemplary only. Although the preferred embodiments of this disclosure have been described herein, improvements and modifications may be incorporated without departing from the scope of the following claims.

1. A coupling arrangement for coupling a work tool to a machine, comprising:
a locking arrangement for locking the work tool to the machine, and
at least two fluid couplers arranged to be connected to each other for establishing a fluid passage between a main pressurized fluid circuit channel of a work tool and a main pressurized fluid circuit channel of a machine,
wherein a driving arrangement is provided for driving at least one of the fluid couplers for connection to the other fluid coupler, the driving arrangement being separate from the main pressurized fluid circuit.

2. The coupling arrangement according to claim 1, wherein the driving arrangement comprises a pressurized fluid circuit.

3. The coupling arrangement according to claim 2, wherein the main pressurized fluid circuit is arranged to operate under a higher pressure than the pressurized fluid circuit of the driving arrangement.

4. The coupling arrangement according to claim 3, wherein the locking arrangement comprises a locking member that is arranged to move between a locking and an unlocked position.

5. The coupling arrangement according to claim 4, wherein the driving arrangement is arranged for driving the locking member and the fluid coupler.

6. The coupling arrangement according to claim 5, wherein a quick release mounting bracket assembly is provided for coupling the work tool to the machine, a first mounting bracket being coupled to the work tool, a second mounting bracket for coupling with the first mounting bracket, being coupled to the machine, wherein the fluid couplers are arranged to extend at least partly within the respective mounting bracket.

7. The coupling arrangement according to claim 6, wherein the fluid couplers are arranged to be in alignment when the work tool is locked to the machine.

8. The coupling arrangement according to claim 7 any of the preceding claims, wherein at least one of the fluid couplers comprises a cover for covering a respective end of a fluid channel extending through the coupler, when the fluid couplers are disconnected.

9. The coupling arrangement according to claim 8, wherein the cover is arranged to be mechanically activated by movement of at least a part of the coupling arrangement.

10. The coupling arrangement according to claim 9, wherein
at least one of the fluid couplers comprises an extendable fluid coupler, provided with a guiding portion and an extendable portion,
the extendable portion is arranged to extend with respect to the guiding portion in the direction of the receiving fluid coupler,
the guiding portion is arranged to remain in fixed position with respect to the coupling arrangement part to which it is coupled, and
a main pressurized fluid circuit channel of the main pressurized fluid circuit is connected to the guiding portion.

11. The coupling arrangement according to claim 10, wherein fluid channels extend centrally through the respective fluid couplers so that during connection of the fluid couplers the main pressurized fluid circuit extends centrally through the fluid couplers.

12. (canceled)

13. A method of coupling a fluid coupler of a machine to a fluid coupler of a work tool, comprising:
locking the work tool to the machine so that the fluid couplers are aligned with each other,
moving at least a part of one of the fluid couplers, with a driving arrangement separate from the main pressurized fluid circuit, in the direction of the other fluid coupler, and
establishing a fluid passage between the fluid coupler of the machine and the fluid coupler of the work tool.

14. The method according to claim 13, further comprising moving a locking member into a locked position.

15. The method according to claim 13, further comprising driving the moving fluid coupler, or part thereof through a second pressurized fluid circuit.

16. The method according to claim 15, further comprising passing pressurized fluid from the main pressurized fluid circuit from the machine to the work tool and/or vice versa, centrally through the fluid couplers.

17. The method according to claim 16, further comprising moving an extendable portion of one of the fluid couplers away from the fluid circuit channel that is connected to the respective one of the fluid couplers.
